(19) United States
(12) Patent Application Publication
(10) Pub. No.: US 2005/0006560 A1
(43) Pub. Date: Jan. 13, 2005

(54) Film forming apparatus and film forming method

(75) Inventors: Masahiro Horie, Kyoto (JP); Hideki Hayashi, Kyoto (JP); Fujikazu Kitamura, Kyoto (JP); Kumiko Akashika, Kyoto (JP)

Correspondence Address: McDermott, Will & Emery, 600 13th Street, N.W., Washington, DC, 20005-3096, US

(73) Assignee: DAINIPPON SCREEN MFG. CO., LTD.

(21) Appl. No.: 10/884,973

(22) Filed: Jul. 7, 2004

(30) Foreign Application Priority Data
Jul. 7, 2003 (JP) P2003-192620

(51) Int. Cl. G01J 1/32; G02F 1/01

(52) U.S. Cl. 250/205; 250/225

(57) ABSTRACT

A film forming apparatus (1) comprises a stage (2) for supporting a substrate (9), a light emitting part (3) for guiding polarized light used for forming an oxide film on the substrate (9) by light energy to a predetermined irradiation region on the substrate (9), a light receiving part (4) for receiving the polarized light reflected on the irradiation region and a calculation part (61) for obtaining a thickness of the film in the irradiation region on the basis of an output from the light receiving part (4). In the film forming apparatus (1), the light emitting part (3) and the light receiving part (4) constitute part of an ellipsometer, and the light emitting part (3) emits a light beam to form a film in the irradiation region on the substrate (9) while the light receiving part (4) acquires the polarization state of the reflected light from the substrate (9) and the calculation part (61) analyzes it to measure the thickness of the film. It is thereby possible to improve the accuracy of film thickness.

### BACKGROUND OF THE INVENTION

1. Field of the Invention

The present invention relates to a technique for forming a film by irradiating an object with light.

2. Description of the Background Art

As a technique for forming a film on a surface of a semiconductor substrate, a glass substrate or the like (hereinafter, referred to as “substrate”), conventionally, a film forming by heating the substrate, the CVD (chemical vapor deposition) method and the like have been used. For example, in a case of forming an oxide film by heating, a chemical reaction between a substrate and oxygen is performed in a high-temperature thermal oxidation furnace, to form an oxide film entirely on the substrate.

On the other hand, the CVD method, where energy required for chemical reaction is supplied to a material gas on a substrate surface and the chemical reaction is thereby promoted to form a film, is broadly divided, depending on the type of supplied energy, into the thermal CVD method using thermal energy, the plasma CVD method using plasma and the photoassisted CVD (photo-CVD) method using light energy.

The photo-CVD method, in which a chemical reaction is promoted by excitation of outershell electrons of gas atoms which is caused by irradiation of a material gas on substrate surface with light, allows film formation at a lower-temperature process as compared with a case of thermal-CVD and has no possibility of damage on a substrate caused by ions or the like unlike the plasma CVD method. Therefore, the photo-CVD method is often used in film formation on a substrate.

For example, a technique for forming an oxide film entirely on a semiconductor substrate by irradiating a process gas containing oxygen with ultraviolet rays is disclosed in Japanese Patent Application Laid Open Gazette No. 2003-133301 (Document 1). Another technique for locally forming a film on a substrate by using a laser beam is suggested in “Optoelectronics—Material and Process Technique” (The Japan Society of Applied Physics, Gathering for Discussion on Optics, Asakura Publishing Company, Ltd., 1986/9/20, p.p. 250-251) (Document 2).

In a case of forming a gate oxide film on a surface of a semiconductor substrate, though an oxide film is conventionally so formed as to have a thickness of about 100 Å by a thermal oxide-film forming method entirely on a substrate at a high temperature of about 1000° C., in recent, it becomes hard for the thermal oxide-film forming method to respond to an increasing demand for formation of thin gate oxide films of uniform thickness, from a viewpoint of control of accuracy of film thickness or the like.

The photo-CVD method is suitable for formation of thin films but makes it hard to form films of uniform thickness because of difficulty in ensuring a uniform distribution of illuminance entirely on a substrate surface. The oxide-film forming apparatus for semiconductor manufacture shown in Document 1 solves this problem by rotating a substrate relatively to point light sources.

In the photo-CVD method, generally, the efficiency of film formation is far from excellent since film formation is performed at a relative low speed. In a case shown in Document 1, since a film is entirely on a substrate like in the thermal oxide-film forming method, if it is intended to form a film partially on a substrate, it is necessary to once form a film entirely on the substrate and then remove unnecessary portions by etching or the like with a mask, and therefore the efficiency of film formation further decreases.

In a case shown in Document 2, though the efficiency of film formation can be improved by locally forming a film with a laser beam, in this case, since an irradiation region of the laser beam on a substrate is intermittently moved in sequence, it becomes necessary to control the temperature, the quantity of irradiation light, the irradiation time, the flow of gas or the like with accuracy in order to uniformize the thickness of a film to be formed in each moving irradiation region, and therefore an apparatus to achieve this technique becomes complicated and expensive.

### SUMMARY OF THE INVENTION

The present invention is intended for a film forming apparatus for forming a film by irradiating an object with light, and it is an object of the present invention to improve the accuracy of film thickness.

According to the present invention, the film forming apparatus comprises a supporting part for supporting an object, a light emitting part for guiding light used for forming a film on the object to a predetermined irradiation region on the object, a light receiving part for receiving the light which is reflected on the irradiation region, and a calculation part for obtaining a thickness of a film in the irradiation region on the basis of an output from the light receiving part.

The film forming apparatus of the present invention locally forms a film by irradiating a predetermined region on a substrate with light while measuring its film thickness with a simple construction, and therefore improves the accuracy of film thickness.

Preferably, the light emitting part and the light receiving part are part of an ellipsometer or an interferometer, depending on the film thickness to be measured.

Further preferably, in order to achieve an automatic control on film thickness with high accuracy, the film forming apparatus further comprises a control part for controlling emission of light from the light emitting part on the basis of a thickness of the film in the irradiation region which is obtained by the calculation part.

According to a specific preferred embodiment, the light emitting part comprises a blue-violet semiconductor laser, a wavelength of light from the light emitting part ranges 200 nm to 450 nm, and the object is a semiconductor substrate and the film is an oxide film. It is therefore possible to ensure efficient formation of an oxide film.

The present invention is also intended for a film forming method for forming a film by irradiating an object with light.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a film forming apparatus in accordance with a first preferred embodiment;

FIG. 2 is a flowchart showing an operation flow of the film forming apparatus for forming an oxide film;

FIG. 3 is a graph showing a relation between the irradiation time of a light beam and the thickness of an oxide film to be formed;

FIG. 4 is another graph showing a relation between the irradiation time of a light beam and the thickness of an oxide film to be formed;

FIG. 5 is a view showing a construction of a film forming apparatus in accordance with a second preferred embodiment;

FIG. 6 is a flowchart showing an operation flow of the film forming apparatus for forming an oxide film; and

FIG. 7 is a graph showing a relation between the wavelength of light to be emitted to a substrate and relative reflectance of the substrate.

### DESCRIPTION OF THE PREFERRED EMBODIMENTS

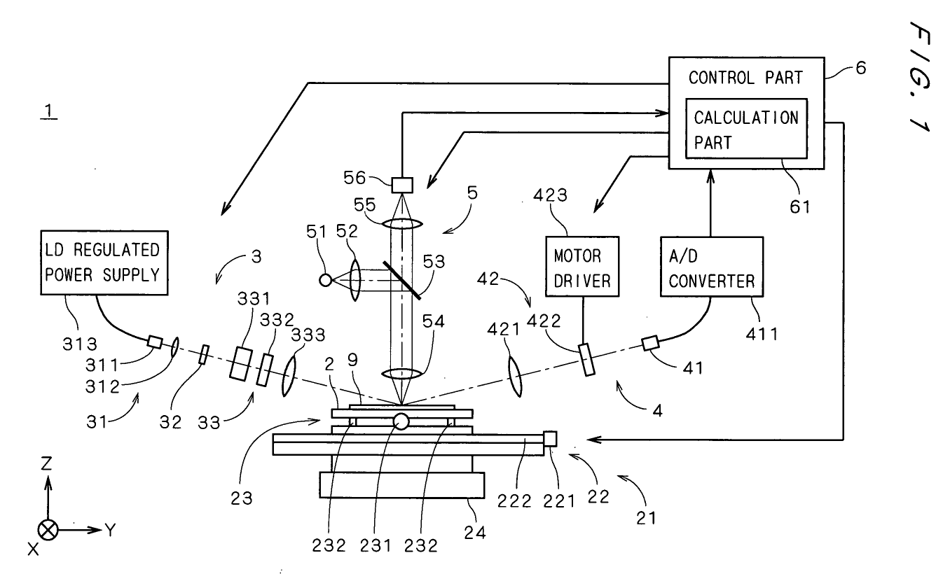

FIG. 1 is a view showing a construction of a film forming apparatus 1 in accordance with the first preferred embodiment of the present invention. The film forming apparatus I is an apparatus for irradiating a semiconductor substrate 9 (hereinafter, referred to as “substrate 9”) with a light beam to form an oxide film in an irradiation region of light beam on the substrate 9 while measuring a film thickness of the irradiation region thereon.

The film forming apparatus 1 comprises a stage 2 for supporting the substrate 9, a stage moving mechanism 21 for moving the stage 2 in X and Y directions of FIG. 1, a stage up-and-down moving mechanism 24 for moving the stage 2 in a Z direction of FIG. 1, a light emitting part 3 for guiding polarized light which is used for forming an oxide film on the substrate 9 with light energy to a predetermined irradiation region on the substrate 9, a light receiving part 4 for receiving the polarized light reflected on the irradiation region, an observation optical system 5 for observing the irradiation region which is irradiated with the polarized light and a control part 6 constituted of a CPU for performing various computations, memories for storing various information and the like.

The stage moving mechanism 21 has a Y-direction moving mechanism 22 for moving the stage 2 in the Y direction and an X-direction moving mechanism 23 for moving the stage 2 in the X direction. In the Y-direction moving mechanism 22, a motor 221 is connected to a ball screw (not shown) and with rotation of the motor 221, the X-direction moving mechanism 23 is moved along guide rails 222 in the Y direction of FIG. 1. The X-direction moving mechanism 23 has the same construction as the Y-direction moving mechanism 22 and with rotation of a motor 231, the stage 2 is moved by a ball screw (not shown) along guide rails 232 in the X direction of FIG. 1.

The light emitting part 3 has a light source part 31 for emitting a light beam towards the substrate 9, an electromagnetic shutter 32 for controlling ON/OFF of emission of light from the light source part 31 towards the substrate 9, and a light-emitting optical system 33 for guiding the light beam which is emitted from the light source part 31 and circularly polarized onto the substrate 9. The light source part 31 has a blue-violet semiconductor laser (hereinafter, referred to as “LD”) 311 for emitting a light beam having a wavelength of 375 nm (nano meter) or 405 nm at output power of 5 mW and a lens 312 for guiding the light beam from the LD 311 to the electromagnetic shutter 32, and an LD regulated power supply 313 is connected to the LD 311. In the light emitting part 3, using the LD 311 as a light source ensures size reduction of the light source part 31.

The light receiving part 4 has a photodiode 41 for acquiring a polarization state of the light reflected on the substrate 9 and a light-receiving optical system 42 for guiding the reflected light from the substrate 9 to the photodiode 41.

The observation optical system 5 has a halogen lamp 51, lenses 52 and 55, an objective lens 54, a half mirror 53 and a CCD 56.

The stage moving mechanism 21, the stage up-and-down moving mechanism 24, the light emitting part 3, the light receiving part 4 and the observation optical system 5 are connected to the control part 6, and the control part 6 controls these constituent elements to form an oxide film in the irradiation region on the substrate 9. The control part 6 has a calculation part 61 for performing various computations and obtains a thickness of the oxide film in the irradiation region by using this calculation part 61 on the basis of an output from the light receiving part 4.

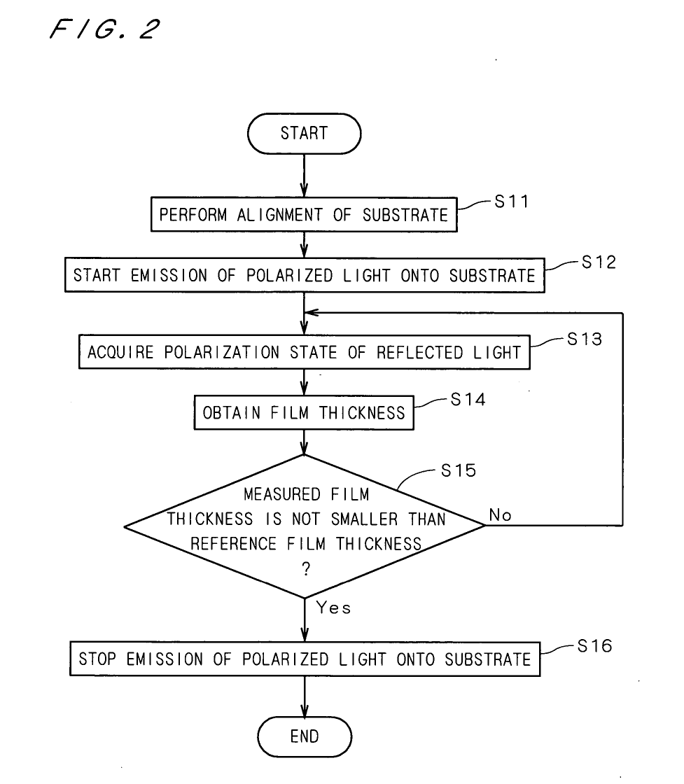

FIG. 2 is a flowchart showing an operation flow of the film forming apparatus 1 for forming an oxide film in the irradiation region on the substrate 9. Hereafter, referring to FIGS. 1 and 2, forming an oxide film by the film forming apparatus 1 will be discussed.

In forming an oxide film on the substrate 9, first, the observation optical system 5 performs alignment (positioning) on the substrate 9. Specifically, illumination light emitted from the halogen lamp 51 is guided through the lens 52 to the half mirror 53 and reflected thereon to enter the substrate 9 through the objective lens 54. The illumination light reflected on the substrate 9 is guided through the objective lens 54, the half mirror 53 and the lens 55 and finally received by the CCD 56. Thus, an alignment mark on the substrate 9 illuminated by the halogen lamp 51 is picked up by the CCD 56, the control part 6 controls the stage moving mechanism 21 and the stage up-and-down moving mechanism 24, on the basis of image data acquired through the image pickup, to move the stage 2, and the substrate 9 is thereby disposed at a predetermined position (Step S11).

Next, in the light emitting part 3, the electromagnetic shutter 32 is opened after stabilizing light emission from the light source part 31 by the LD regulated power supply 313, and a light beam from the LD 311 goes through the lens 312 and the electromagnetic shutter 32 in sequence and enters the light-emitting optical system 33. The light-emitting optical system 33 has a polarizer 331, a crystal wave plate (hereinafter, referred to as “quarter-wave (λ/4) plate”) 332 and a collimator lens 333 from a side of the electromagnetic shutter 32 towards the substrate 9. The light beam which enters the light-emitting optical system 33 is linearly polarized by the polarizer 331 and further circularly polarized by the λ/4 plate 332. The light from the λ/4 plate 332 is guided to the substrate 9 while being converged by the collimator lens 333 having a numerical aperture (NA) of 0.1. In the light emitting part 3, as discussed above, with opening of the electromagnetic shutter 32, light emission of the polarized light towards the irradiation region on the substrate 9 is started (Step S12).

At this time, the polarized light enters the substrate 9 from the light emitting part 3, being inclined at an incident angle of 72 degrees, with which the circular irradiation region having a diameter of about 10 μm (micrometers) is irradiated at luminance of about 5 W/mm², and with this energy, an oxide film is formed in the irradiation region on the substrate 9. Specifically, oxygen molecules on a surface of the substrate 9 absorb the light energy and are photo-decomposed by excitation, and the thus-formed oxygen radicals oxidize the substrate 9 to form an oxide film thereon. Further reduction in size of the irradiation region is possibly achieved by increasing the numerical aperture of the collimator lens 333.

The polarized light reflected on the substrate 9 enters the light-receiving optical system 42 having a collimator lens 421 and a rotating analyzer 422. The rotating analyzer 422 is installed inside a hollow rotation shaft of a stepping motor and a motor driver 423 is connected to the stepping motor. The control part 6 controls the stepping motor to rotate the rotating analyzer 422 about an axis parallel to an optical axis, thereby guiding the reflected light from the substrate 9 through the rotating analyzer 422 to the photodiode 41. The photodiode 41 transmits a signal indicating the intensity of the received light to the control part 6 through an A/D converter 411. At that time, a measurement area on the substrate 9 is defined large by the collimator lens 421 and the numerical aperture of the light-receiving optical system 42 with respect to the substrate 9 is set to 0.05 for limitation of reflection angle of the light towards the photodiode 41, which is reflected on the substrate 9.

Then, the calculation part 61 in the control part 6 associates an output from the photodiode 41 with the rotation angle of the rotating analyzer 422 (a so-called rotating analyzer method) to acquire the polarization state of the reflected light, i.e., the phase difference between a p-polarized component and an s-polarized component of the reflected light and an angle whose tangent gives an amplitude ratio of reflected polarized components (i.e., a complex amplitude ratio) (Step S13). The calculation part 61 further performs ellipsometry on the basis of the acquired polarization state of the reflected light to obtain a thickness of the oxide film formed in the irradiation region on the substrate 9, optical constants or the like (Step S14).

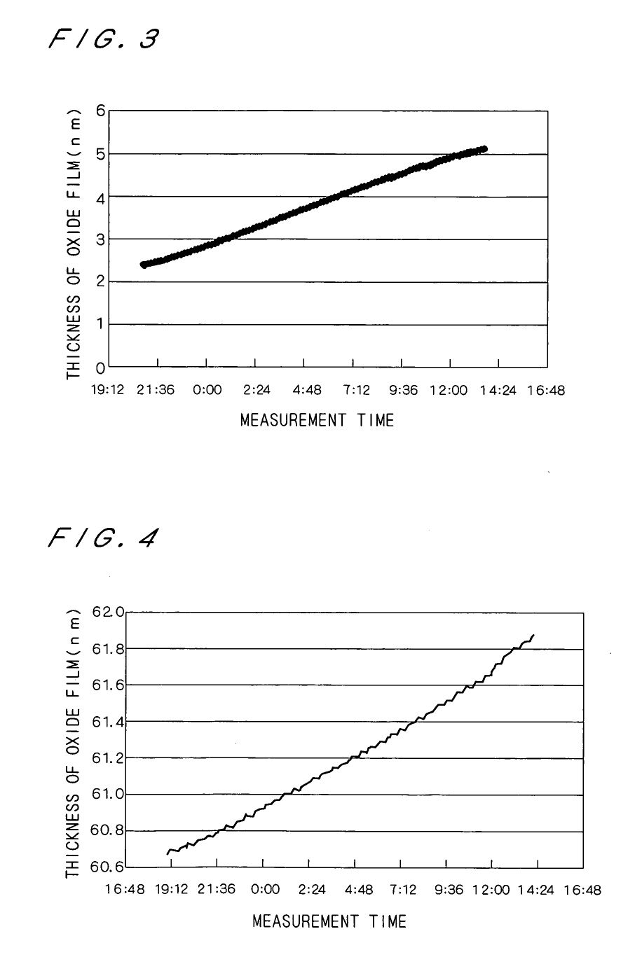

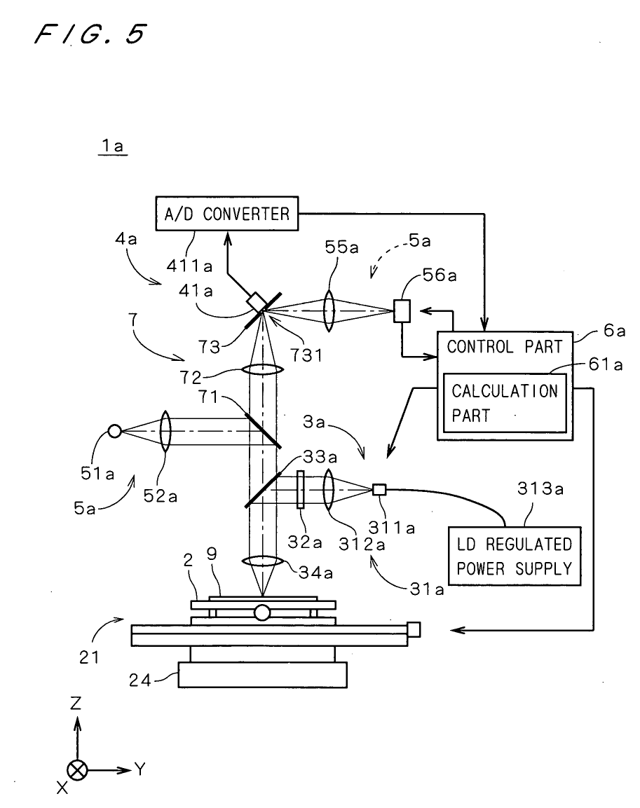

FIGS. 3 and 4 are graphs showing a relation between the irradiation time of a light beam having a wavelength of 405 nm and the thickness of an oxide film which is formed on the substrate 9 by the film forming apparatus 1 in an open atmosphere with room temperature and atmospheric pressure, where the horizontal axis indicates the measurement time and the vertical axis indicates the thickness of an oxide film in an irradiation region on the substrate 9 which is obtained by the calculation part 61. As shown in FIG. 3, in a state where the thickness of the film formed on the substrate 9 is several nm, the speed to increase the film thickness in film forming is about 0.18 nm/hour. As shown in FIG. 4, in a state where the thickness of the film formed on the substrate 9 is about 60 nm, the speed to increase the film thickness in film forming is about 0.06 nm/hour, which is smaller than that in a case where a relatively thin film is formed on the substrate 9. Thus, it is possible, in the film forming apparatus 1, to measure the thickness of an oxide film formed on the substrate 9 with high accuracy of 0.1 nm (1 Å) or less.

The measured thickness of the oxide film (hereinafter, referred to as “measured film thickness”) is compared with a predetermined film thickness which is stored in the control part 6 in advance (hereinafter, referred to as “reference film thickness”) to judge if the measured film thickness is not smaller than the reference film thickness (Step S15). When the measured film thickness is smaller than the reference film thickness, back in Step S13, forming of the oxide film is continued, and the operations for acquiring the polarization state of the reflected light from the substrate 9 and obtaining the thickness of the oxide film (Steps S13 and S14) are repeated until the measured film thickness becomes not smaller than the reference film thickness (Step S15). When the measured film thickness becomes not smaller than the reference film thickness, the control part 6 controls the electromagnetic shutter 32 to close and emission of the polarized light from the light emitting part 3 onto the substrate 9 is stopped (Step S 16).

Thus, in the film forming apparatus 1, it is possible to locally form an oxide film with high resolution by emitting a light beam from the light emitting part 3 to the substrate 9. Since the light emitting part 3 and the light receiving part 4 constitute part of an ellipsometer and the light beam used for film formation is also used by film-thickness measurement, it is possible to form an oxide film in an irradiation region on the substrate 9 while measuring the film thickness thereof with high accuracy with simple construction, without misalignment between a forming position of the oxide film and a measurement position of its film thickness. Especially, the construction of the apparatus can be largely simplified as compared with a case where a construction for forming an oxide film and a construction for measuring its film thickness are separately provided. Moreover, since irradiation of the irradiation region with light is controlled by controlling ON/OFF of light emission from the light emitting part 3 on the basis of the measurement film thickness in the irradiation region on the substrate 9, it is possible to form an oxide film having a predetermined thickness through a high-precision control on film thickness.

The film forming apparatus 1, in which the polarized light enters the substrate 9, being inclined, and the thickness of an oxide film in the irradiation region is obtained by ellipsometry using the reflected light from the substrate 9, is suitable for forming a relatively thin film on the substrate 9 and measuring its thickness with high accuracy. Especially, the film forming apparatus 1, which is capable of forming a thin film while performing control on film thickness with high accuracy, is suitable for formation of an oxide film which is used for a gate or the like on a semiconductor substrate.

In the film forming apparatus 1, the wavelength of the light beam from the light emitting part 3 is not limited to 375 nm or 405 nm, but may be changed as appropriate depending on the type of film to be formed on the substrate 9. Considering, however, that the light beam can photodecompose gas molecules to efficiently form a film and can be practically used for measurement of film thickness, it is preferable that the wavelength of the light beam from the light emitting part 3 should be in the range from 200 nm to 450 nm.

FIG. 5 is a view showing a construction of a film forming apparatus 1a in accordance with the second preferred embodiment of the present invention. The film forming apparatus 1a, like the film forming apparatus 1 of the first preferred embodiment, emits a light beam in an irradiation region on the substrate 9 and receives the reflected light from the substrate 9 to measure the film thickness of the irradiation region while forming an oxide film on the irradiation region of the light beam.

The film forming apparatus 1a comprises a light emitting part 3a for guiding light which is used for forming an oxide film on the substrate 9 with light energy to an irradiation region on the substrate 9, a light receiving part 4a for receiving the light reflected on the irradiation region, an observation optical system 5a for observing the irradiation region, a control part 6a constituted of a CPU for performing various computations, memories for storing various information and the like and a main optical system 7 which shares part of constituents of the observation optical system 5a.

The film forming apparatus la also comprises the stage 2 for supporting the substrate 9, the stage moving mechanism 21 for moving the stage 2 in X and Y directions of FIG. 5 and the stage up-and-down moving mechanism 24 for moving the stage 2 in a Z direction of FIG. 5, like the film forming apparatus 1 of FIG. 1. In the following description, the same constituent elements identical to those in the film forming apparatus 1 are represented by the same reference signs.

The light emitting part 3a has a light source part 31a having a blue-violet semiconductor laser (LD) 311a and a lens 312a, an electromagnetic shutter 32a, a half mirror 33a and an objective lens 34a, and an LD regulated power supply 313a is connected to the LD 311a. The light receiving part 4a has a photodiode 41a for acquiring intensity of the reflected light from the substrate 9.

The observation optical system 5a has a halogen lamp 51a, lenses 52a and 55a and a CCD 56a. The main optical system 7 has a half mirror 71, a lens 72 and a pinhole mirror 73. Distinction between the observation optical system 5a and the main optical system 7 is made for convenience of discussion, and in effect, the halogen lamp 51a, the lens 52a, the half mirror 71 and the objective lens 34a constitute an optical system for guiding illumination light for observation to the substrate 9, and the objective lens 34a, the lens 72, the pinhole mirror 73, the lens 55a and the CCD 56a constitute an optical system for observing the substrate 9.

The stage moving mechanism 21, the stage up-and-down moving mechanism 24, the light emitting part 3a, the light receiving part 4a and the observation optical system 5a are connected to the control part 6a, and the control part 6a controls these constituent elements to form an oxide film in the irradiation region on the substrate 9. The control part 6a has a calculation part 61a for performing various computations and the calculation part 61a substantially obtains a thickness of the oxide film in the predetermined irradiation region on the basis of an output from the light receiving part 4a.

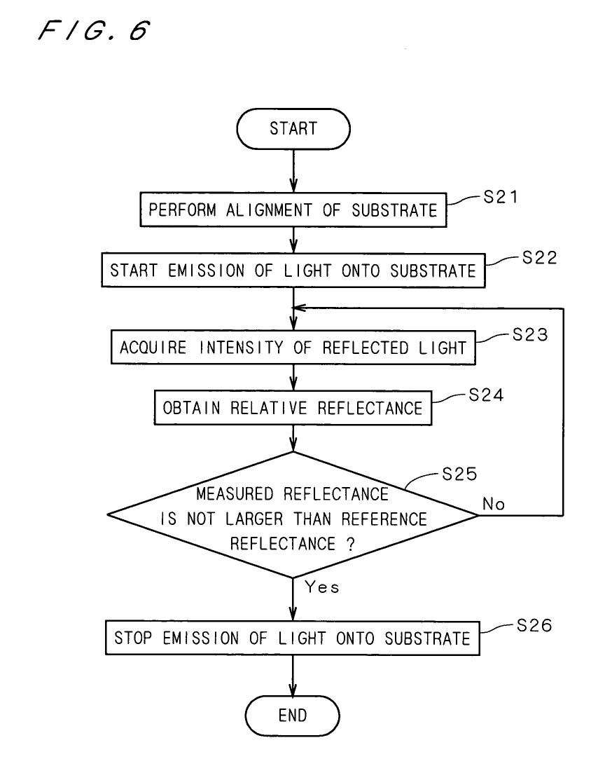

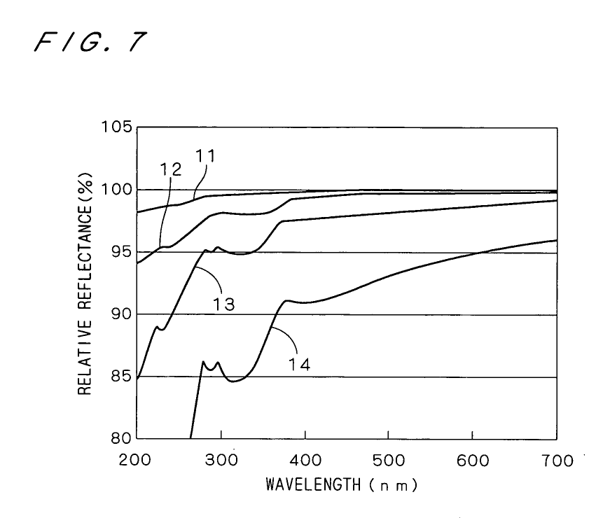

FIG. 6 is a flowchart showing an operation flow of the film forming apparatus 1a for forming an oxide film in the irradiation region on the substrate 9. Hereafter, referring to FIGS. 5 and 6, forming an oxide film by the film forming apparatus la will be discussed.

In forming an oxide film on the substrate 9, first, the observation optical system 5a and the like perform alignment on the substrate 9. Specifically, illumination light emitted from the halogen lamp 51a is guided through the lens 52a to the half mirror 71 and reflected thereon to enter the substrate 9 through the half mirror 53a and the objective lens 34a in sequence. The illumination light reflected on the substrate 9 is guided through the objective lens 34a, the half mirrors 33a and 71 and the lens 72 in sequence to the pinhole mirror 73 and reflected thereon to be finally received by the CCD 56a through the lens 55a. Thus, an alignment mark on the substrate 9 illuminated by the halogen lamp 51a is picked up by the CCD 56a, the control part 6a controls the stage moving mechanism 21 and the stage up-and-down moving mechanism 24, on the basis of image data acquired through the image pickup, to move the stage 2, and the substrate 9 is thereby disposed at a predetermined position (Step S21).

Next, in the light emitting part 3a, the electromagnetic shutter 32a is opened after stabilizing light emission from the LD 311a by the LD regulated power supply 313a, and a light beam from the LD 311a goes through the lens 312a and the electromagnetic shutter 32a in sequence and enters the half mirror 33a. The light beam reflected on the half mirror 33a is guided through the objective lens 34a to the substrate 9 and light emission of the light beam towards the irradiation region on the substrate 9 is started (Step S22).

At this time, the light beam perpendicularly enters the substrate 9 from the light emitting part 3a, with which the irradiation region is irradiated to form an oxide film on the substrate 9, as shown in FIG. 5. In this case, it is even possible to set the size (width, diameter and the like) of the irradiation region on the substrate 9 to smaller than 1 μm by changing the setting on the optical system of the light emitting part 3a (e.g., the lens 312a or the objective lens 34a).

The light beam reflected on the substrate 9 is guided through the objective lens 34a, the half mirror 33a and 71 and the lens 72 in sequence to the pinhole mirror 73 and passes through a pinhole 731 of the pinhole mirror 73 which is disposed, being optically conjugate to the irradiation region on the substrate 9, to be received by the photodiode 41a. A signal from the photodiode 41a is transmitted through an A/D converter 411a to the control part 6a and the intensity of the reflected light from the substrate 9 is thereby acquired (Step S23). Between the pinhole 731 and the photodiode 41a may be provided a band pass filter for passing only light having a wavelength of the light beam emitted from the LD 311a (hereinafter, referred to as “LD wavelength”).

From data indicating the intensity of the acquired reflected light and the intensity of the reflected light from an object which is prepared in advance for reference (e.g., a semiconductor substrate with no film formed on its surface, and hereinafter, referred to as “reference substrate”), the calculation part 61a of the control part 6a obtains relative reflectance (in other words, reflectance which is relatively obtained with respect to the reference substrate) of the irradiation region on the substrate 9 with respect to the light of LD wavelength (Step S24).

FIG. 7 is a graph showing a relation between the wavelength of light to be emitted to the substrate 9 and the relative reflectance of the substrate 9 (the relative reflectance with respect to a substrate with no film formed thereon) for each thickness of an oxide film on the substrate 9 having a surface on which the oxide film is formed. In FIG. 7, lines 11, 12, 13 and 14 represent relative reflectances of oxide films having thicknesses of 2 nm, 5 nm, 10 nm and 20 nm, respectively.

When an oxide film is formed on the substrate 9, as shown in FIG. 7, the relative reflectance of the substrate 9 gradually decreases as the thickness of the oxide film increases. Therefore, by measuring the relative reflectance and controlling light emission of the light beam on the basis of the measurement result, it is possible to set the thickness of the oxide film on the substrate 9 to a predetermined value. In other words, obtaining the relative reflectance is substantially equivalent to obtaining the film thickness.

Specifically, relative reflectance with respect to light of LD wavelength (hereinafter, referred to as “reference reflectance”) in a predetermined thickness of a film to be formed on the substrate 9 is a stored in the control part 6a in advance and the reference reflectance is compared with the relative reflectance obtained by the calculation part 61a (hereinafter, referred to as “measured reflectance”) to judge if the measured reflectance is not larger than the reference reflectance (Step S25). When the measured reflectance is larger than the reference reflectance, back in Step S23, the forming of the oxide film is continued and the operations for acquiring the intensity of the reflected light from the substrate 9 and obtaining the relative reflectance (Steps S23 and S24) are repeated until the measured reflectance becomes not larger than the reference reflectance (Step S25). When the measured reflectance becomes not larger than the reference reflectance, the control part 6a controls the electromagnetic shutter 32a to close and emission of the light beam from the light emitting part 3a onto the substrate 9 is stopped (Step S26).

Thus, in the film forming apparatus 1a, the light emitting part 3a and the light receiving part 4a constitute part of an interferometer and it is thereby possible to form an oxide film in an irradiation region on the substrate 9 with high resolution while measuring the film thickness thereof with high accuracy with simple construction. Especially, the construction of the apparatus can be largely simplified as compared with a case where a construction for forming an oxide film and a construction for measuring its film thickness are separately provided. Moreover, it is possible to form an oxide film having a predetermined thickness through a high-precision control on film thickness on the basis of the measurement result.

The film forming apparatus 1a, in which the light beam perpendicularly enters the substrate 9 and the thickness of an oxide film in the irradiation region can be easily obtained by light interferometry using the reflected light from the substrate 9, is suitable for forming a relatively thick film on the substrate 9 or forming another film on an already-formed film (multilayer film) while performing measurement of its thickness with high accuracy.

Also in the film forming apparatus 1a, like in the first preferred embodiment, light of other wavelengths may be used for film formation, and it is preferable that the wavelength of light for film formation should be in the range from 200 nm to 450 nm.

Though the preferred embodiments of the present invention have been discussed above, the present invention is not limited to the above-discussed preferred embodiments, but allows various variations.

For example, a plurality of blue-violet semiconductor lasers may be provided in the light emitting part. In this case, one irradiation region may be irradiated with a plurality of light beams to increase an area of the irradiation region and its illuminance. Instead of the blue-violet semiconductor laser, other lasers or other light sources such as light emitting diodes may be used.

Control of ON/OFF of light emission to the substrate 9 by direct control of the light source allows omission of the electromagnetic shutter. By feedback of a result of the film-thickness measurement to the control part, it is possible to control not only ON/OFF of light emission but also the intensity of light to be emitted from the light source.

Various changes on the construction for measurement of film thickness may be made. For example, in the film forming apparatus 1 of the first preferred embodiment, linearly polarized light whose polarization direction is rotated (i.e., the polarization direction changes with time) may be guided by the light emitting part 3 to the irradiation region on the substrate 9. In this case, a rotating polarizer is provided in the light-emitting optical system 33 instead of the polarizer 331 and the λ/4 plate 332 and a fixed analyzer is provided in the light-receiving optical system 42 instead of the rotating analyzer 422, to measure the intensity of the reflected light by the photodiode 41. Then, the intensity of the reflected light is associated with a rotation angle of the rotating polarizer to acquire the polarization state of the reflected light and the thickness of the film formed in the irradiation region can be thereby obtained.

In the film forming apparatus 1a of the second preferred embodiment, a spectroscope may be provided instead of the photodiode 41a. In this case, a light source (e.g., a xenon (Xe) lamp or the like) for emitting white light is provided in the light source part instead of the LD 311 and using the spectral intensity of the reflected light which is acquired by the spectroscope allows measurement of film thickness performed by general light interferometry.

Forming oxide film by the film forming apparatus of the above preferred embodiments may be performed in a closed space under an atmosphere of predetermined process gas containing oxygen (O₂) gas. For example, the substrate 9, the stage 2, the stage moving mechanism 21 and the stage up-and-down moving mechanism 24 may be disposed in a chamber provided with a window for passing the light from the light emitting part, the reflected light from the substrate 9 and the like, and in this case, the effect of the window in the chamber is corrected when the film thickness or the relative reflectance is obtained by the calculation part. In order to improve the efficiency of formation of oxide films, a pressure inside the chamber may be changed as appropriate. A film (e.g., nitride film or the like) other than the oxide film may be formed by changing the process gas.

In the film forming apparatus, though an oxide film is formed on the substrate 9 with high resolution (i.e., accuracy of thickness) by photodecomposition of oxygen molecules, if required resolution is relatively low, an oxide film may be formed by heating the irradiation region on the substrate 9 with the emitted light. In other words, light energy may be indirectly used for film forming.

The shape, size, illuminance or the like of the irradiation region on the substrate 9 in the film forming apparatus may be suitably determined in accordance with the characteristics of a film to be formed on the substrate 9, the required resolution or the like.

Though control on film thickness by control on light emission for film formation is automatically performed on the basis of the measurement result of film thickness or relative reflectance in the above preferred embodiments, the light emission may be controlled manually while checking the measurement result. In other words, the film thickness is substantially measured by using the light for film forming and it is thereby possible to improve the accuracy of thickness of a film to be formed.

The substrate 9 on which a film is formed by the film forming apparatus is not limited to a semiconductor substrate but may be a glass substrate used for, e.g., liquid crystal displays or other flat panel displays.

While the invention has been shown and described in detail, the foregoing description is in all aspects illustrative and not restrictive. It is therefore understood that numerous modifications and variations can be devised without departing from the scope of the invention.

1. A film forming apparatus for forming a film by irradiating an object with light, comprising:
a supporting part for supporting an object;
a light emitting part for guiding light used for forming a film on said object to a predetermined irradiation region on said object;
a light receiving part for receiving said light which is reflected on said irradiation region; and
a calculation part for obtaining a thickness of a film in said irradiation region on the basis of an output from said light receiving part.

2. The film forming apparatus according to claim 1, wherein
said light emitting part and said light receiving part are part of an ellipsometer and polarized light enters said object from said light emitting part, being inclined.

3. The film forming apparatus according to claim 1, wherein
said light emitting part and said light receiving part are part of an interferometer and light perpendicularly enters said object from said light emitting part.

4. The film forming apparatus according to claim 1, further comprising
a control part for controlling emission of light from said light emitting part on the basis of a thickness of said film in said irradiation region which is obtained by said calculation part.

5. The film forming apparatus according to claim 1, wherein
a wavelength of light from said light emitting part ranges 200 nm to 450 nm.

6. The film forming apparatus according to claim 5, wherein
said light emitting part comprises a blue-violet semiconductor laser.

7. The film forming apparatus according to claim 1, wherein
said object is a semiconductor substrate and said film is an oxide film.

8. A film forming method for forming a film by irradiating an object with light, comprising:
a light emitting step for emitting light used for forming a film on an object to a predetermined irradiation region on said object;
a light receiving step for receiving said light which is reflected on said irradiation region by a light receiving part;
a calculation step for obtaining a thickness of a film in said irradiation region on the basis of an output from said light receiving part; and
a control step for controlling emission of said light onto said irradiation region on the basis of said thickness of said film in said irradiation region.

9. The film forming method according to claim 8, wherein
polarized light enters said object, being inclined, in said light emitting step and said thickness of said film in said irradiation region is obtained by ellipsometry in said calculation step.

10. The film forming method according to claim 8, wherein
said light perpendicularly enters said object in said light emitting step and said thickness of said film in said irradiation region is obtained by light interferometry in said calculation step.

11. The film forming method according to claim 8, further comprising
a light-emission control step for controlling emission of light onto said object on the basis of said thickness of said film which is obtained.

12. The film forming method according to claim 8, wherein
a wavelength of light to be emitted onto said object ranges 200 nm to 450 nm.

13. The film forming method according to claim 12, wherein
said light is emitted from a blue-violet semiconductor laser.

14. The film forming method according to claim 8, wherein
said object is a semiconductor substrate and said film is an oxide film.
